(19) United States
(12) Patent Application Publication
(10) Pub. No.: US 2002/0162035 A1
(43) Pub. Date: Oct. 31, 2002

(54) Interface circuit and disk drive apparatus

(75) Inventor: Akira Tsukihashi, Ohra-gun (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 10/082,829

(22) Filed: Feb. 20, 2002

(30) Foreign Application Priority Data
Apr. 13, 2001 (JP) 2001-115918

(51) Int. Cl. G06F 1/26; G06F 1/28; G06F 1/30

(52) U.S. Cl. 713/300

(57) ABSTRACT

A CPU (28) determines, based on a signal from a power source determination circuit (30), whether or not power is supplied from an external power source. When power is supplied from an external power source, the CPU (28) controls the USB interface (16) to operate as a ver. 2.0 interface. When power is not supplied from an external power source, the CPU (28) controls the USB interface (16) to operate as a ver. 1.1 an interface, thereby reducing power consumption.

### BACKGROUND OF THE INVENTION

1. Field of the Invention

The present invention relates to an interface circuit for USB data transfer and to a disk drive apparatus using the same.

2. Description of the Related Art

Conventional compact disks, or CDs, include CD-R (CD recordable) and CD-RW (CD rewritable) CDs, onto which data can be written. A user can write data into such a disk, and a much larger amount of data as compared to that which can be written onto comparable removable media such as magnetic floppy disks or the like. Because of their advantages, CDs have come to be widely used in computer drives and the like.

A disk drive apparatus used for data writing converts data received from a computer into a disk writing data format before actual disk writing. An independent disk drive apparatus adapted to external attachment requires a standardized data communication interface so that the apparatus can be reliably used for general purposes.

As such an interface, the USB (Universal Serial Bus) interface is known and widely employed. In particular, the USB interface Ver. 1.1 is widely used, while the USB interface ver. 2.0 is presently becoming more common.

While a data transfer rate is 12 Mbps according to USB ver. 1.1, the data transfer rate according to USB ver. 2.0 is 480 Mbps. Therefore, whereas the data writing speed into a CD according to USB ver. 1.1 is limited to no more than 6× (six times standard) speed, with USB ver. 2.0, there is no practical limitation due to the data transfer rate according to USB ver. 2.0. It should be noted that USB ver. 2.0 supports USB ver. 1.1.

A USB interface includes a power supply bus, via which the computer can supply power to a connected apparatus.

Meanwhile, data transfer at a higher speed requires a faster interface operation clock to achieve faster data processing, and a faster interface operation clock will in turn result in larger power consumption by the circuit operating according to such a clock.

Therefore, increase of the data transfer rate results in a problem that power consumption by the interface becomes so large to power supply to the circuit proves insufficient.

### SUMMARY OF THE INVENTION

The present invention has been conceived to overcome the above problem, and aims to provide an interface circuit capable of providing an adequate, suitable power supply to an interface, and a disk drive apparatus utilizing that interface circuit.

According to the present invention, a USB interface can switch operation clocks and data transfer rates, respectively, according to the capacity of its power source. Specifically, when provided with a power source of larger capacity, the interface may employ a faster clock for data transfer at a higher rate. When provided with a power source of smaller capacity, on the other hand, a slower clock may be employed to reduce power consumption.

### BRIEF DESCRIPTION OF THE DRAWINGS

The above and other objects, features, and advantages of the present invention will become further apparent from the following description of the preferred embodiment taken in conjunction with the accompanying drawings wherein:

FIG. 1 is a block diagram showing a complete structure of a disk drive apparatus in an embodiment of the present invention; and

FIG. 2 is a flowchart showing operation of the embodiment.

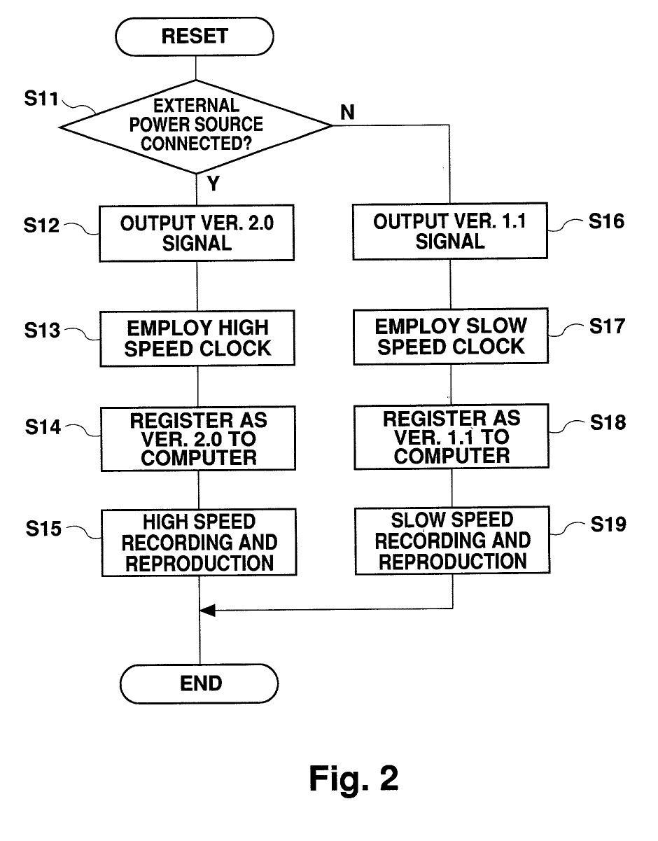

### DESCRIPTION OF THE PREFERRED EMBODIMENT

In the following, a preferred embodiment of the present invention will be described with reference to the accompanying drawings.

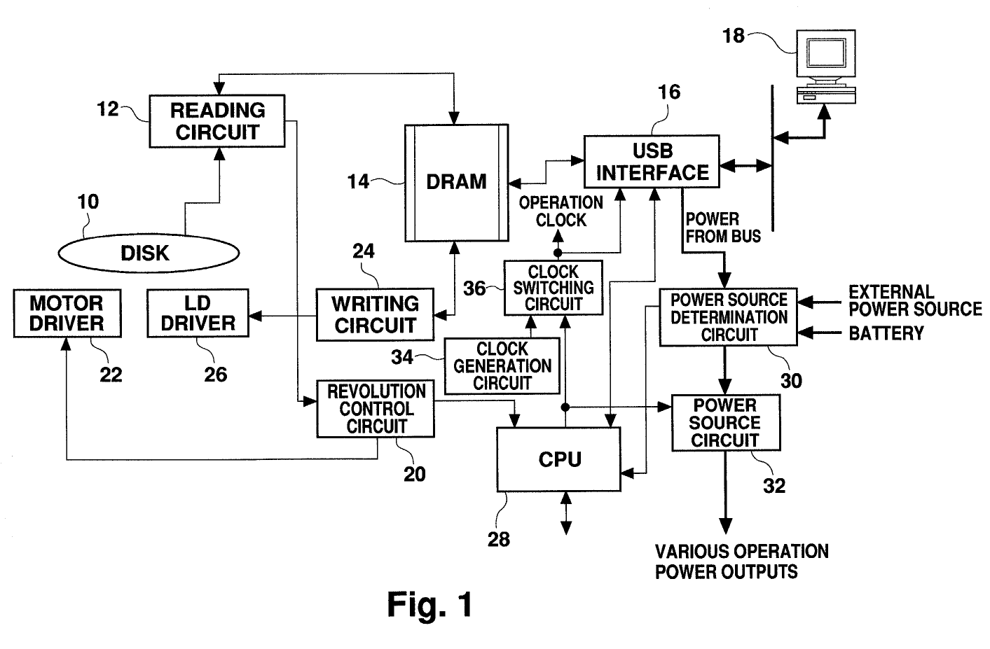

FIG. 1 is a block diagram showing a complete structure of a disk drive apparatus of the present embodiment. A disk 10 is a rewritable CD, such as, for example, they type used in a CDR drive. A signal optically read from the disk 10, or a read signal, is supplied to a reading circuit 12, where processing including decoding is applied to the signal, and is then stored in a DRAM 14. The data stored in the DRAM 14 is supplied via a USB interface 16 to a computer 18. It should be noted that the system may be configured so as to allow direct output of an audio signal or the like.

A read signal from the disk 10 is supplied to a revolution control circuit 20, which in turn generates a revolution control signal for the disk 10 based on an Absolute Time In-Pre-Groove, or ATIP, contained in a pre-groove of a disk, or data read from the disk 10. The revolution control signal is supplied to a motor driver 22 to control the number of revolutions of the disk. Here, it should be noted that a read signal from the reading circuit 12 may also be used for tracking control.

Data to be written, or “writing data”, from a computer 18 is written via the USB interface 16 into the DRAM 14, and then undergoes processing including encoding in a writing circuit 24 before being supplied to an LD driver 26. The LD driver 26 controls a laser light source such that the data is written onto the disk 10.

The DRAM 14 may also be used for data decoding in the reading circuit 12 and for data encoding in the writing circuit 24.

This apparatus is provided with a CPU 28 for controlling operations of various circuits of the apparatus.

Here, the USB interface 16 of the apparatus is manufactured according to the USB Standard, and has two or more buses, including one for power supply. The power supply bus of the USB interface 16 is connected to a power source determination circuit 30. The power source determination circuit 30, which is further connected to a power line from a battery and another from an external power source such as an AC adapter, determines through which bus or line the apparatus receives power, and notifies the CPU 28 of the determination result.

Power from a plurality of power source supplied to the power source determination circuit 30 is also supplied to the power source circuit 32, from which appropriate operating power is supplied to various circuits.

Specifically, the power source circuit 32 incorporates a DC/DC converter, and outputs three levels of powers, namely, 3.3 V, 5 V, and 2.5 V, to various circuits. The power source circuit 32 also incorporates a power switching circuit, or a power switching means, for switching between a power output for ver. 1.1 and that for ver. 2.0 in response to a control signal from the CPU 28. For example, when supplying power output for ver. 1.1, the power source circuit 32, which may have two or more current output transistors, may maintain a predetermined number of transistors in an OFF state so that a reduced amount of power can be supplied.

The apparatus also incorporates a clock generation circuit 34 to support operations of its internal circuits. The clock generation circuit 34 outputs at least two types of operating clocks, namely one for ver. 1.1 and another for ver. 2.0. Specifically, the clock generation circuit 34 may have two oscillators, or, alternatively, may generate a clock for ver. 1.0 by dividing a clock for ver. 2.0.

Two types of clocks output from the clock generation circuit 34 are supplied to the clock switching circuit 36, which then switches between a ver 1.1 clock and a ver. 2.0 clock in accordance with a control signal from the CPU 28.

As described above, in an apparatus according to this embodiment, the power source circuit 32 and the clock switching circuit 36 switch between respective ver. 1.1 outputs and ver. 2.0 outputs according to a control signal from the CPU 28. Power consumption can be reduced when ver. 1.1 output is employed.

In the following, mode switching by the CPU 28 will be described. Initially, at the time of resetting, such as turning on of the power or establishment of connection with the computer 18, the CPU 28 responsive to a signal from the power source determination circuit 30 detects presence or absence of power supplied from an external power source (S11). When presence of power supplied from an external power source is detected, the CPU 28 sets a high power mode, and outputs a control signal for ver. 2.0 (S12). In response to this signal, the power source circuit 32 outputs a high power current, and the clock switching circuit 36 switches outputs to a high frequency output (S13). In addition, the CPU 28 sends a signal via the USB interface 16 to the computer 18 to register therein the concerned drive apparatus as a ver. 2.0 drive (S14). Thereafter, predetermined high speed data transfer is carried out between the computer 18 and the USB interface 16 for high speed recording and reproduction (S15).

Returning to Step 11, when no external power source is detected, that is when absence of power supplied from an external power source is determined, the CPU 28 sets a power saving mode, and outputs a control signal for ver. 1.1 (S16). In response to this signal, the power source circuit 32 outputs a low power current, and the clock switching circuit 36 switches outputs to a low frequency output (S17). In addition, the CPU 28 sends a signal via the USB interface 16 to the computer 18 to register therein the concerned drive apparatus as a ver. 1.1 drive (S18), with the result that predetermined low speed data transfer is then employed between the computer 18 and the USB interface 16 for low speed recording and reproduction (S19).

As described above, in this embodiment, the amount of operation current and the type of operation clocks to be supplied to the USB interface 16 are adjusted according to the type of power source in use. With this arrangement, the disk drive apparatus of the present invention serves as a USB ver. 2.0 drive in a high mode, conducting highest speed recording and reproduction when it is connected to an external power source and thus supplied with sufficient power, and, when it is not connected to an external power source and thus not supplied with sufficient power, serves as a USB ver. 1.1 drive, conducting slow speed recording and reproduction, so that recording and reproduction is conducted for reduced power consumption.

Power consumption of the USB interface 16 in a high power mode in which the disk drive apparatus functions as a USB ver. 2.0 drive will be approximately 250 mA, while that in a power saving mode in which the disk drive apparatus functions as a USB ver. 1.1 drive will be approximately 30 mA. The present invention is applicable not only to CDs but also to DVDS, for example.

What is claimed is:

1. An interface circuit for USB data transfer, comprising:
a power source determination circuit for determining a type of power source;
a power feeding switching circuit for setting an amount of current to be supplied to a processing circuit conducting processing for data transfer, based on a result of determination made by the power source determination means; and
a clock switching circuit for setting operation clocks for the processing circuit according to a result of determination made by the power source determination means,
wherein
a data transfer rate is set according to the type of power source.

2. The interface circuit according to claim 1, wherein
the power source determination circuit determines whether an external power source is connected, and
when it is determined that an external power source is connected, the power feeding switching circuit increases the amount of current and the clock switching circuit sets a faster clock, so that high speed data transfer is carried out, and
when it is determined that no external power source is connected, the power feeding switching circuit causes to reduce the amount of current and the clock switching circuit sets a slower clock, so that slow speed data transfer is carried out.

3. The interface circuit according to claim 2, wherein the interface circuit operates as a USB ver. 2.0 interface circuit when an external power source is connected, and operates as a USB ver. 1.1 interface circuit when no external power source is connected.

4. The interface circuit according to claim 3, which is registered as a USB ver. 2.0 interface circuit in a computer connected thereto when an external power source is connected, and as a ver. 1.1 interface circuit when no external power source is connected.

5. A disk drive apparatus comprising the interface circuit according to claim 1, for writing data supplied from a computer onto a recording disk.

6. The disk drive apparatus according to claim 5, wherein the disk drive apparatus sends the computer data concerning a data transfer rate at a time of resetting of the interface circuit.
